(19) United States
(12) Patent Application Publication
(10) Pub. No.: US 2022/0282998 A1
(43) Pub. Date: Sep. 8, 2022

(54) LINEAR MOTION SENSOR

(71) Applicant: Hella GmbH & Co. KGaA, Lippstadt (DE)

(72) Inventors: Adrian NOVAC, Timisoara (RO); Bogdan NYIREDI, Timisoara (RO); Stelian ROMAN, Timisoara (RO)

(73) Assignee: Hella GmbH & Co. KGaA, Lippstadt (DE)

(21) Appl. No.: 17/827,330

(22) Filed: May 27, 2022

Related U.S. Application Data
(63) Continuation of application No. PCT/EP2019/083062, filed on Nov. 29, 2019.

(51) Int. Cl. G01D 5/20

(52) U.S. Cl. CPC G01D 5/2053; G01D 2205/10

(57) ABSTRACT

A linear sensor for detecting a length or a linear movement, the linear sensor comprising a first part having a first electromagnetic coil as excitation coil and having at least one second electromagnetic coil as receiver coil that encloses a first surface, and a second part having an electrically conductive coupling element, into which an electromagnetic field generated by the excitation coil can be coupled, whereby eddy currents can be generated in the coupling element which generate an electromagnetic field which can be coupled into the at least one receiver coil in order to change a voltage applied to the at least one receiver coil. The second part being linearly movable relative to the first part.

This nonprovisional application is a continuation of International Application No. PCT/EP2019/083062, which was filed on Nov. 29, 2019, and which is herein incorporated by reference.

### BACKGROUND OF THE INVENTION

### Field of the Invention

The present invention relates to a linear sensor with which a distance or a linear movement, in particular the speed of the linear movement, can be recorded.

### Description of the Background Art

Linear sensors for detecting distances or movements with a coil that generates an electromagnetic field that is disturbed by an electrically conductive element are known from the state of the art.

Also known are rotation sensors with a coil that generates an electromagnetic field that is disturbed by a rotor made of an electrically conductive material, whereby an angle or rotational movement can be detected. One application of such a sensor, for example, is disclosed in document DE 199 41 464 A1, which corresponds to U.S. Pat. No. 6,384,598, which is incorporated herein by reference. The sensor disclosed in DE 199 41 464 A1 has one excitation coil and several receiving coils. An oscillator circuit generates a periodic alternating voltage signal and couples it into the excitation coil. This generates a first electromagnetic field. In this field, a rotor is rotatably arranged as a coupling element. In this coupling element, an eddy current is generated by the first electromagnetic field, which in turn generates a second electromagnetic field. The fields overlap to form a resulting field that is coupled into the receiving coils and influences the voltages applied to the receiving coils. Depending on the angular position of the rotor, this results in a different resulting electromagnetic field. This field also changes as a function of any rotational movement of the rotor. This changes the voltage applied to the receiving coils as a function of the rotational position and movement of the rotor. The influence of the voltage applied to the receiving coils is detected by an evaluation circuit.

The sensor described in document DE 199 41 464 A1, including the evaluation circuit, has been produced in large quantities in recent years and has proven itself over the past 20 years. The evaluation circuit is usually implemented as an integrated circuit, in particular as an application-specific integrated circuit, ASIC.

The inventors now had the task of finding further fields of application for the sensor known from document DE 199 41 464 A1 with excitation coil, at least one receiver coil and a coupling element or a similar sensor, in particular for the evaluation circuit of the sensor.

### SUMMARY OF THE INVENTION

It is therefore an object of the present invention to provide a linear sensor in accordance with the invention for detecting a length or a linear movement has a first part with a first electromagnetic coil as excitation coil and with at least one second electromagnetic coil as receiver coil, which encloses a first surface, and a second part with an electrically conductive coupling element, into which an electromagnetic field generated by said excitation coil can be coupled, whereby eddy currents can be generated in said coupling element which generate an electromagnetic field which can be coupled into said at least one receiver coil to vary a voltage applied to said at least one receiver coil, said second part being linearly movable relative to said first part.

Components of the rotation sensor can be used for the linear sensor according to the invention. But instead of detecting rotational movements or angles, the linear sensor is designed to detect distances and linear movements. In particular, it is possible that the evaluation circuit of the known or a similar rotation sensor is used for the inventive linear sensor, while other components are modified. In any case, the known or a similar rotation sensor must be modified so that a linear movement is possible instead of a rotary movement between the excitation coil and at least one receiving coil on the one hand and the coupling element on the other hand.

In addition to this fundamental difference to the well-known rotation sensor or a similar rotation sensor, further modifications are possible which serve to enable better, more accurate and/or simpler detection of the distance or linear motion.

It is possible that a sensor according to the invention has two receiver coils electrically connected in series. These receiver coils electrically connected in series must be wound in the opposite direction. Each of the receiving coils may have radial sections starting from a common centre and arcuate sections running on a circular line around the centre. The radial sections of the two receiving coils run parallel to each other or congruently, while in a first angular range the circular sections of one receiving coil run on an inner circular line around the centre and the circular sections of the other receiving coil run on an outer circular line around the centre. In angular ranges adjacent to this first angular range, the opposite is true: the arc-shaped sections of one receiving coil run on the outer circular line around the center and the arc-shaped sections of the other receiving coil run on an inner circular line around the center. The angular areas can have a width of 90°.

The receiver coils connected in series may enclose the first surface. The first surface may, for example, be bounded by the outer circular line on which the radially outer arc-shaped sections of the two receiver coils are arranged.

The first part of the linear sensor may have a third electromagnetic coil as reference coil. The reference coil may include an area equal to or nearly equal to the first area. In addition, the receiver coils connected in series may be viewed together and the reference coil may have the same or almost the same magnetic flux.

The first part of a linear sensor according to the invention may comprise a printed circuit board on which the excitation coil, at least one receiver coil and/or the reference coil are arranged. The coils can be provided as conductor tracks on the liner plate.

The coupling element of a linear sensor can be a closed conductor loop.

The second part of an invented linear sensor can comprise a printed circuit board on which the coupling element is arranged. The closed conductor loop can be designed as a conductor track on the printed circuit board.

It is possible that the coils or the closed conductor loop are stamped parts that have been die-cut from a sheet metal.

The linear sensor can have an integrated circuit to which the excitation coil and at least one receiver coil and, if applicable, the reference coil are electrically connected. The integrated circuit can have an evaluation circuit of the sensor according to the invention.

Preferably, the coupling element of a linear sensor according to the invention is arranged in a plane parallel to the first surface and the second part is preferably movable perpendicular to the first surface.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows the routing of conductor tracks on a printed circuit board of a first part of a sensor according to the invention, whereby the conductor tracks form two receiver coils and a reference coil;

FIG. 2 shows an electrical equivalent circuit diagram of the arrangement of the coils on the liner plate of the first part; and

FIG. 3 shows the routing of the conductor track on a printed circuit board of a second part of a sensor according to invention.

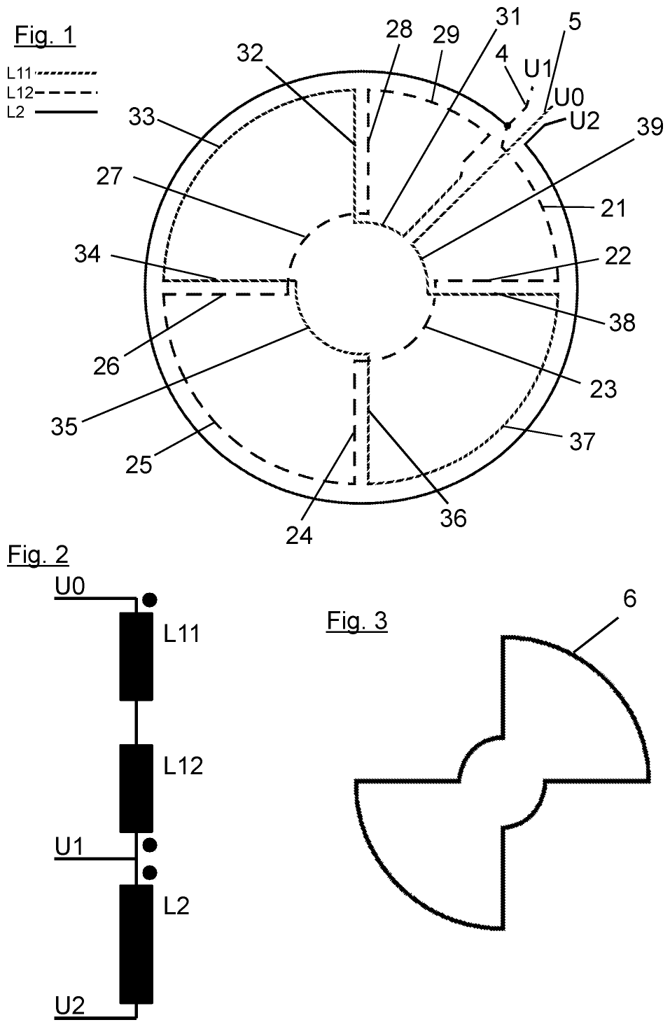

### DETAILED DESCRIPTION

The routing of the conductor tracks 1, 2, 3 forming the receiver coils L11, L12 and the reference coils L2 on the printed circuit board of the first part and the routing of the closed conductor loop 6 on the printed circuit board of the second part as illustrated in FIG. 3 has turned out to be advantageous in experiments. The first and the second part of a sensor according to the invention are arranged in such a way that the circuit boards of a sensor according to the invention can be moved parallel to each other.

Together with an evaluation unit of the sensor from the document DE 199 41 464 A1 or a similar sensor it is possible to detect linear movements between the first and the second part or distances between the first and the second part of the sensor.

The first track 1 forming the reference coil lies on a circular path. The ends of this first track 1 are connected to connections which are also formed by tracks 4, 5 and which lead radially outwards. The first track 1 forming the reference coil encloses a first surface.

A second and a third track 2, 3 are arranged within the first track 1 to form the receiver coil. The second track 2 has a first end, which is connected to one of the tracks 4, to which the first track 1 is connected. This second track 2 has sections 21, 25, 29 running on an outer circular path, sections 23, 27 running on an inner circular path and radial sections 22, 24, 26, 28 connecting the sections running on the inner and outer circular paths. A second end of the second track 2 is connected to a first end of the third track 3 by a connecting track 4. The third track 3 also has sections 33, 37 running on an outer circular path, sections 31, 35, 39 running on an inner circular path and radial sections 32, 34, 36, 38 connecting the sections running on the inner and outer circular paths. A second end of the third conductor track 3 is connected to the evaluation unit via a connecting conductor track 5.

The sections of the second and third conductor paths running on the inner and outer circular paths each extend over an angle of approx. 90°. The outer sections run in close proximity to the first track 1 of the reference coil. The inner sections and the outer sections of the second and third tracks 2, 3 are alternating.

This design means that the second track 2 and the third track 3 are basically the same shape, but rotated 90° to each other. This makes it possible that the two tracks 2, 3 together enclose approximately the same area as the first track. Each of the two tracks 2, 3 encloses approximately the same area as the other of the tracks 2, 3.

In addition, the second and third conductor tracks are connected to each other via the connecting conductor track 4 in such a way that it is possible that the second and third conductor tracks or the receiver coils formed by these conductor tracks have a different winding direction, which is also shown in the equivalent circuit diagram (FIG. 2). A homogeneous magnetic flux through the area enclosed by the two conductor tracks 2, 3 therefore has a different effect in the receiver coils.

The closed conductor loop 6 of the coupling element, which is formed on the printed circuit board of the second part, is approximately congruent with each of the second and third conductor loops. However, it is approximately congruent with the second conductor loop. An electric eddy current and the electromagnetic field generated by the eddy current therefore have a different effect on the second conductor loop than on the third conductor loop. The electromagnetic field emitted by the coupling element therefore has a different effect on a voltage applied to the receiver coils. It has been found that at a decreasing distance between the first and second parts, a voltage applied to the receiver coil formed by the second conductor loop 2 decreases at a decreasing distance, while at the same time a voltage applied to the receiver coil formed by the third conductor loop 3 increases. If the distance between the first and the second part increases, the reverse occurs. The voltage in one receiver coil does not decrease to the same extent as the voltage in the other receiver coil increases. The sum of the voltage dropping across both receiver coils is therefore not constant if the distance between the first and second part changes.

The arrangement of the first part and the second part can be designed in such a way that the voltage across the two receiver coils is 0 Volt in an initial position. If the distance is subsequently reduced, it increases to a value of 1 Volt, which can be evaluated by the evaluation unit and converted into a signal indicating the distance.

The coupling element and the change in the electromagnetic field caused by the closed conductor loop 6 of the coupling element, which is generated by an excitation coil that is not shown, has only an influence on the receiver coils, but not on the electromagnetic field, which permeates the first surface as a whole and thus the reference coil with the first conductor path 1. A voltage at the reference coil remains without change if the first and the second part are moved to each other.

For example, the excitation coil can be excited with an alternating voltage at a frequency of 3 to 4 MHz to generate the electromagnetic field.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A linear sensor for detecting a length or a linear movement, the linear sensor comprising:
a first part having a first electromagnetic coil as an excitation coil and having at least one second electromagnetic coil as a receiver coil that encloses a first surface; and
a second part having an electrically conductive coupling element into which an electromagnetic field generated by the excitation coil is adapted to be coupled, wherein eddy currents are generated in the coupling element which generate an electromagnetic field, which can be coupled into the at least one receiver coil in order to change a voltage applied to the at least one receiver coil, and wherein the second part is linearly movable relative to the first part.

2. The linear sensor according to claim 1, wherein the sensor has two receiver coils electrically connected in series.

3. The linear sensor according to claim 2, wherein the receiver coils electrically connected in series are wound in opposite directions.

4. The linear sensor according to claim 2, wherein the receiver coils connected in series enclose the first surface.

5. The linear sensor according to claim 1, wherein the first part comprises a third electromagnetic coil as reference coil.

6. The linear sensor according to claim 4, wherein the reference coil includes an area which corresponds or nearly corresponds to the first area, and the receiver coil connected in series and the reference coil are permeated by the same or nearly the same magnetic flux.

7. The linear sensor according to claim 1, wherein the first part comprises a printed circuit board on which the excitation coil, the at least one receiver coil and/or the reference coil are arranged.

8. The linear sensor according to claim 1, wherein the coupling element is a closed conductor loop.

9. The linear sensor according to claim 1, wherein the second part comprises a printed circuit board on which the coupling element is arranged.

10. The linear sensor according to claim 1, wherein the linear sensor comprises an integrated circuit to which the excitation coil and the at least one receiver coil and optionally the reference coil are electrically connected.

11. The linear sensor according to claim 1, wherein the coupling element is arranged in a plane parallel to the first surface and the second part is movable perpendicular to the first surface.
